(19) United States
(12) Patent Application Publication
(10) Pub. No.: US 2006/0158867 A1
(43) Pub. Date: Jul. 20, 2006

(54) Electro-luminescent illuminated dinnerware

(76) Inventor: Kyu-Woong Lee, Milpitas, CA (US)

Correspondence Address: KYU WOONG LEE, 199 BALBOA DR, MILPITAS, CA, 95035, US

(21) Appl. No.: 11/035,857

(22) Filed: Jan. 14, 2005

(51) Int. Cl. F21V 33/00; F21V 9/16

(52) U.S. Cl. 362/84; 362/154; 362/253

(57) ABSTRACT

Electro-luminescent illuminated dinnerware with a dinnerware item such as a bowl, plate or cup that employs a length of electro-luminescent wire equal to the length of the circumference of a dinnerware item into a grooved portion about the top most perimeter of the dinnerware item and capped by a transparent enclosing ring. A channel traveling up the dinnerware item retains a pair of insulated wires. The dinnerware item has a recessed base that retains a power supply such as a battery, a step up transformer, and a switch. The items in the recessed base are connected in a standard way to the electro-luminescent wire so that the perimeter edge of the dinnerware item appears to glow when the switch is activated.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of dinnerware and more specifically to electro-luminescent illuminated dinnerware. Items of dinnerware such as plates, bowls and cups for the purpose of supporting food during meals have been in use for many hundreds of years. In the never ending quest to design new and novel dinnerware, some designers and inventors have proposed incorporating various types of lighting devices in conjunction with a power source into items such as mugs so that they light up during use. Although these illuminated cups and mugs do indeed provide a novel approach to dinnerware, they tend to be designed for molded plastic applications and to not be applicable to a variety of materials that dinnerware is commonly made of such as metal, glass, wood or ceramic.

### BRIEF SUMMARY OF THE INVENTION

The primary object of the invention is to provide dinnerware that has a glowing edge about its topmost perimeter.

Another object of the invention is to provide a means to illuminate the edge of dinnerware that is made out of standard materials such as metal, wood, ceramic or glass.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed electro-luminescent illuminated dinnerware comprising: a dinnerware item such as a bowl, plate or cup, a length of electro-luminescent wire equal to the length of the circumference of a dinnerware item, said dinnerware item having a grooved portion about its top most perimeter capable of retaining an electro-luminescent wire, a transparent enclosing ring capable of enclosing said electro-luminescent wire, a channel traveling up said dinnerware item that can retain an pair of insulated wires, said dinnerware item having a recessed base, a power supply such as a battery, a step up transformer, and a switch, wherein said power supply and step-up transformer and said switch are concealed in said recessed base and connected in a standard way to said electro-luminescent wire so that the perimeter edge of said dinnerware item appears to glow when said switch is activated.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a side section view of the invention.

FIG. 3 is a perspective view of an alternate embodiment of the invention,

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

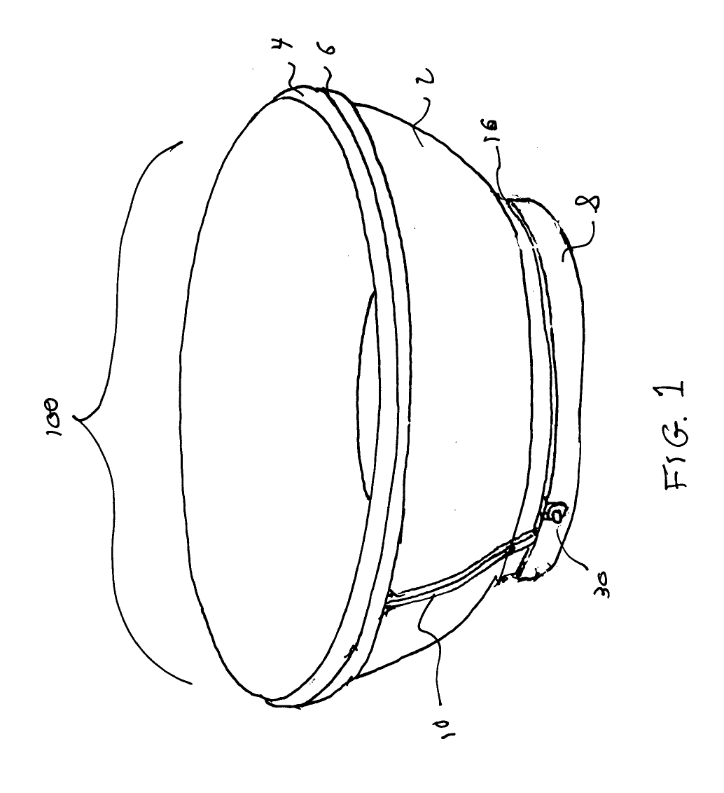

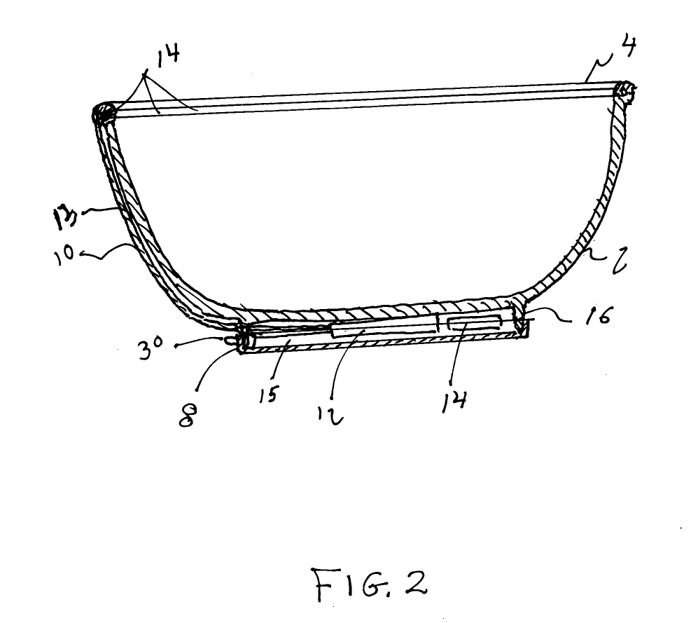

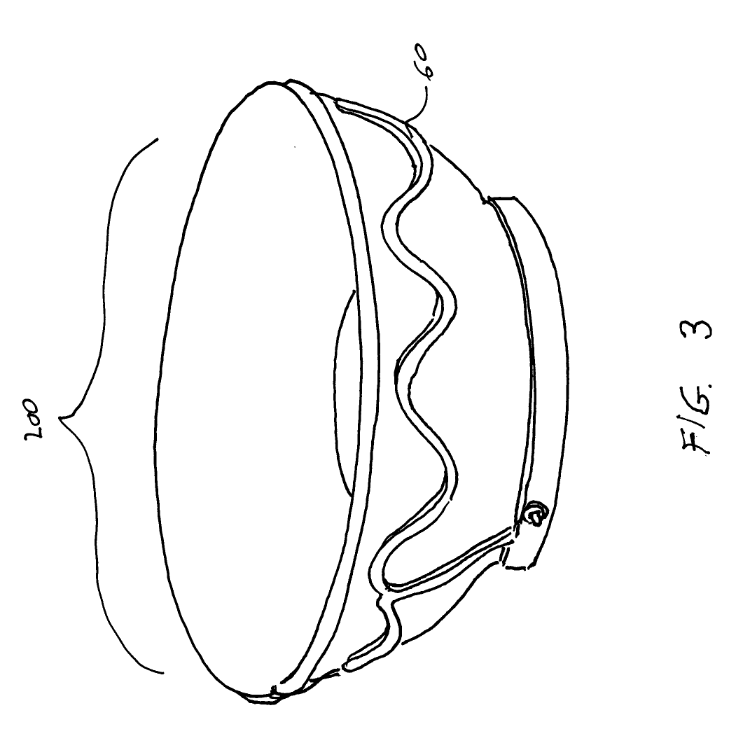

Referring now to FIG. 1 we see a perspective view of the dinnerware bowl of the present invention 100. The bowl looks similar to standard dinnerware and the main bowl portion 2 can be made of a variety of materials such as glass, metal, ceramic, plastic or wood. A top ring 4 is made of transparent or translucent material such as glass or acrylic plastic and is bonded to the main body 2 at joint line 6. A channel 10 is located at one location on the bowl 2 and a switch 30 located in the base portion 8 can activate an electro-luminescent wire 14 located below the transparent ring 4 as shown in FIG. 2. The 24 gauge wire is coated with semiconductor material and is known as electro-luminescent wire. One source of this wire is the Live Wire Enterprise Company of Flushing, N.Y. The wire can be made to blink on and off. The wire draws only one tenth of a milliamp per foot, so it can remain illuminated for long periods of time by use of a small power source such as a AA battery 14. It is available in a variety of colors such as red, white, blue, pink, green, yellow, lavender, ice blue and orange. The wire needs one hundred and twenty volts to operate, so a step-up transformer 12 is required. The transformer 12 power supply 14 and on/off switch are housed within a recess 15 in the base 16 of the bowl. A pair of insulated wires 13 is retained by channel housing 10. The wires 13 connect the step-up transformer 12 to the electro-luminescent wire 14. The resulting effect is that when the electro-luminescent wire 14 is activated by switch 30, the wire glows through transparent cover ring 14 producing a novel illuminating effect. Obviously, the same technology can be applied in a similar way to the top ridge of a plate or mug. In this way, a complete set of dinnerware can be manufactured having illuminated top perimeter edges. The dinnerware can be styled for classic adult tastes or can be whimsically styled for party or child use. An alternate embodiment of the invention 200 is shown in FIG. 3 where, instead of the electro-luminescent wire being placed on the top perimeter edge of the bowl, it is placed in a wave pattern 60 around the side of the bowl. Obviously, a wide variety of designs can be envisioned when using the electro-luminescent wire as a decorative element including multiple wires having multiple colors powered by one power source and located on one dinnerware item.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Electro-luminescent illuminated dinnerware comprising:
a dinnerware item such as a bowl, plate or cup;
a length of electro-luminescent wire equal to the length of the circumference of a dinnerware item;
said dinnerware item having a grooved portion about its top most perimeter capable of retaining an electro-luminescent wire;
a transparent enclosing ring capable of enclosing said electro-luminescent wire;
a channel traveling up said dinnerware item that can retain an pair of insulated wires;
said dinnerware item having a recessed base;
a power supply such as a battery;
a step up transformer; and
a switch;
wherein said power supply and step-up transformer and said switch are concealed in said recessed base and connected in a standard way to said electro-luminescent wire so that the perimeter edge of said dinnerware item appears to glow when said switch is activated.

2. An alternate embodiment of the electro-luminescent dinnerware as claimed in claim 1 wherein said electro-luminescent wire is placed along the side of said dinnerware in a decorative pattern.
